(19) United States
(12) Patent Application Publication
(10) Pub. No.: US 2021/0110314 A1
(43) Pub. Date: Apr. 15, 2021

(54) BROADCAST IDENTIFIER BASED NOTIFICATION

(71) Applicant: Lenovo (Singapore) Pte. Ltd., Singapore (SG)

(72) Inventors: Robert Kapinos, Durham, NC (US); Russell VanBlon, Raleigh, NC (US); Robert J. Norton, Raleigh, NC (US); Scott Wentao Li, Cary, NC (US)

(21) Appl. No.: 16/600,235

(22) Filed: Oct. 11, 2019

(51) Int. Cl. G06Q 10/02; H04W 68/02; H04W 48/10; G06Q 50/12

(52) U.S. Cl. CPC G06Q 10/02; G06Q 50/12; H04W 48/10; H04W 68/02

(57) ABSTRACT

A computer implemented method includes receiving a broadcast identifier at a reservation system that was broadcast from a user mobile device via a wireless transmission, generating a notification that a user associated with the user mobile device has arrived, and providing the notification to a user interface to indicate that the user has arrived. The broadcast identifier may be a MAC address received via WiFi received by a router and forwarded to the reservation system.

### BACKGROUND

Web and app-based appointment reservations are becoming more common. A problem still remains of telling a busy enterprise that you have arrived, so that you can be served. In fixed time appointments there is the issue of people arriving late, or parties not being completely arrived. In first come first served appointments, some people might arrive prior to others, but be behind them in the queue. In all these situations, operator intervention is required to update the status of the person being served to everyone. Arguments occur over who arrived first and who got noticed first.

### SUMMARY

A computer implemented method includes receiving a broadcast identifier at a reservation system that was broadcast from a user mobile device via a wireless transmission, generating a notification that a user associated with the user mobile device has arrived, and providing the notification to a user interface to indicate that the user has arrived. The broadcast identifier may be a MAC address received via WiFi received by a router and forwarded to the reservation system.

### BRIEF DESCRIPTION OF THE DRAWINGS

FIG. 1 is a block diagram of a system for detecting user devices according to an example embodiment.

FIG. 2 is a flowchart illustrating a computer implemented method of providing a notification based on a broadcast identifier indicative of the presence of a user associated with a user device according to an example embodiment.

FIG. 3 is a flowchart illustrating a computer implemented method of providing a notification based on a broadcast identifier indicative of the presence of multiple users in a party associated with respective user devices according to an example embodiment.

FIG. 4 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term. “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

There are many applications or apps that run on user devices that can be used to inform a service enterprise, like a restaurant that the user has arrived. The user marks in an app when they has arrived. This requires the user to have an app for every restaurant. Alternatively, users are interviewed by establishment personnel such as a host or receptionist and marked present and perhaps put on a waiting list. Such a process is subject to manual error and requires attentive personnel who may be very busy at a given time, such as at a restaurant during evening meal time. Apps may use geolocation to detect that the user/user device has arrived. Such apps require the user to have an app for every restaurant, which can be wasteful of user device resources and confusing to the user.

In various embodiments of the present inventive subject matter, a system detects a WiFi mac address of a user device or multiple user devices holding a reservation or spot in a queue for one or more users. The WiFi mac address may be provided when making the reservation or joining a queue using a reservation system. The WiFi mac address(es) of the device(s) of the party may be provided in advance when making reservation via a Web based sign-up, or learned from a user profile such as a Google sign-in.

User's may find a user device WiFi MAC address on their wireless devices, such as phones or tables via a user interface menu related to wireless devices and Wi-Fi settings or hardware information, or advanced settings. The MAC address may be stored in the reservation system following the first reservation for ease of making future reservations or may be stored on a user profile of one of many different web or app based systems, such as OpenTable that may be used to interface into an establishment's reservation system. The reservation system can work off a leader mac address, or the mac address of corresponding user devices of everyone in the party at the restaurant's discretion. While embodiments are described with respect to a restaurant, many other establishments or enterprises may benefit from such a system, including but not limited to departments of motor vehicles, medical offices, food trucks, take-out food queues, and even retail or wholesale stores for checking out.

The WiFi mac addresses are unique and publicly broadcast to any listening radio, such as a WiFi router used by the establishment. When the party arrives, the WiFi router takes notice of the party via detection of the WiFi address or addresses and sends an alert to the reservation system. The reservation system marks them present without any human interaction. Sign boards, electronic table trackers, and reservation databases may be automatically updated with the information that the party is present. If desired, the party is advanced in any queues over people who are not marked present. If the establishment has integrated signaling such as SMS for table ready, the signaling automatically enabled when the party is present to inform the user via text, email, or any other form of communication.

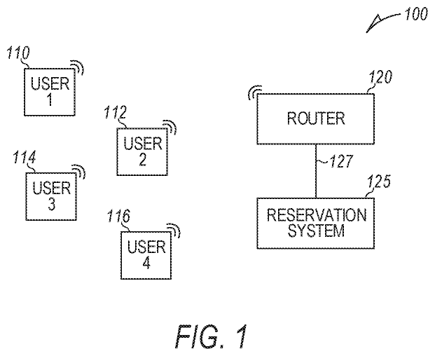

FIG. 1 is a block diagram of a system 100 for detecting user devices 110, 112, 114, and 116. A WiFi router is illustrated at 120. The WiFi router 120 receives broadcast mac address signals from user devices 110, 112, 114, and 116 that are within range. Receipt of such mac addresses corresponds to the users, such as persons, being present for a reservation, as the range of such a router is highly indicative of such a presence. Router 120 may also be coupled to a network, such as the Internet.

A MAC address is unique for each device and may include a 48-bit unique identifier assigned to a network interface controller included in each smart device. In further embodiments, any other type of device unique identifier may be used that is detectable within a limited range, such as common range of a WiFi or Bluetooth type of network device. Bluetooth or other short-range wireless protocol may be used to detect a broadcast unique device identifier in further embodiments. Signal strength of such devices may also be used in further embodiments to detect that a patron is near or present.

In one embodiment, a reservation system 125 is coupled via wired or wireless connection 127 to communicate with the router 120. The WiFi router is programmed in one embodiment to send the detected WiFi mac addresses to the reservation system 125. The reservation system 125 may also be coupled via wired or wireless connection, such as through router 120, to receive and save-web based reservations that include WiFi mac addresses of one or more user devices on each reservation. As the WiFi mac addresses are received by the reservation system 125, the addresses are compared to those corresponding to the stored reservations.

As one or more persons for each reservation are detected, the reservation system may mark the reservation party as present. Optionally, the detected presence of one person in a reservation, or at least a lead person may result in the reservation party being marked present. In other embodiments, all persons are detected, or a majority or preselected number of persons to result in the party being marked as present. Once marked, the reservation may be surfaced to an electronic sign with an appropriate open table assigned to the group. In other embodiments a service person such as a host or hostess may be informed of the group and call for them to be led to a table. The reservation system may take advanced reservations or may also manage a queue of people waiting for a table or other service. Not being present may result in people being pushed down in the queue.

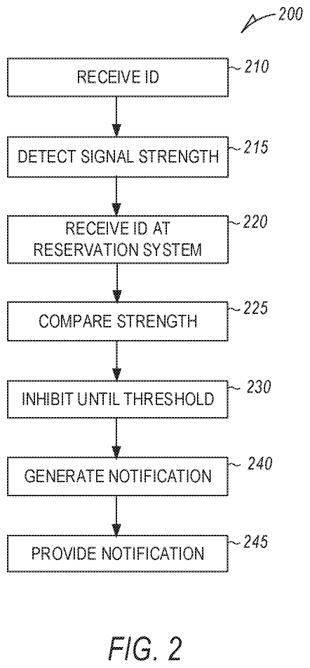

FIG. 2 is a flowchart illustrating a computer implemented method 200 of providing a notification based on a broadcast identifier indicative of the presence of a user associated with a user device. Method 200 begins by receiving a broadcast identifier at operation 210 from a user mobile device via a wireless transmission. The broadcast identifier in one embodiment comprises a MAC address or other unique identifier of a user device, and the broadcast identifier is received via WiFi at a router. In one embodiment, a signal strength of the wireless transmission may be optionally detected at operation 215.

At operation 220, the received identifier is received by a reservation system, and may include a signal strength. The detected signal strength may be compared at operation 225 to a threshold signal strength. The threshold signal strength may be determined empirically by testing based on different positions of user devices being within a range thought to be close enough to be counted as available for acceptance of the service. Such a range could be the maximum range of the router receiving the broadcast MAC addresses or may be a range within a building such that the user of the user device is available for immediate communication with a representative of the establishment or within sight of one or more display devices displaying a queue of patrons. Thus, the threshold may be set by the establishment based on establishment preferences and layout of the establishment. Note that in different embodiments, the comparison operation 225 may be performed in the router, or in the reservation system. If performed in the router, the signal strength need not be sent to the reservation system.

In the event that the threshold compare operation 225 is utilized, the next operation is inhibited at operation 230. Otherwise, operation 240 is performed to generate a notification that a user associated with the user mobile device has arrived. At operation 245, the notification is provided to a user interface to indicate that the user has arrived.

In one embodiment, the notification is provided to one or more display devices. The notification may include a name of the user that is displayed on the one or more display devices, such as a large screen located in a restaurant.

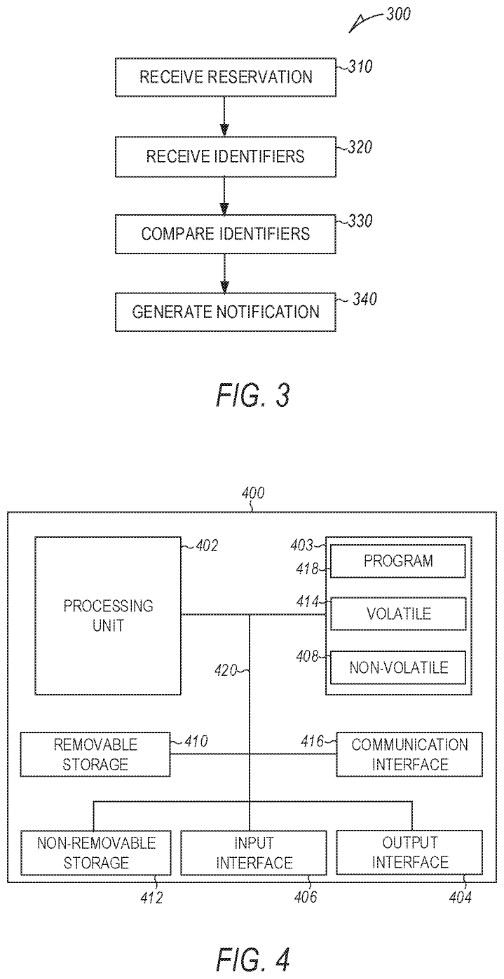

FIG. 3 is a flowchart illustrating a computer implemented method 300 of providing a notification based on a broadcast identifier indicative of the presence of multiple users in a party associated with respective user devices. Method 300 begins at operation 310 wherein a reservation is received at a reservation system. The reservation may identify at least one person by name and by a unique identifier corresponding to a MAC address or other identifier that the person/user's user device may broadcast. In addition, several other unique identifiers corresponding to multiple other people/users in a group or party may also be received as associated with the reservation.

In response to one or more of the users in the party being near the establishment corresponding to the reservation, multiple identifiers are received from the multiple users at operation 320 corresponding to the multi-person reservation. At operation 330 the received identifiers are compared to identifiers associated with the multi-person reservation. The comparison may be based on a selected number of the identifiers being received, optionally utilizing the threshold comparison previously described. The selected number may range from one of the identifiers having been received, more than one identifier, or all of the identifiers having been received corresponding to the entire party being present. At operation 340, A notification is generated and provided in response to the comparison. Waiting to send the notification until all in the party or group have arrived may result in a more efficient utilization of establishment personnel as only one trip to escort the party to a service area, such as a table may be made.

FIG. 4 is a block schematic diagram of a computer system 400 to implement one or more devices and methods to detect user devices and correlate the presence of such devices with reservations for services or products. All components need not be used in various embodiments.

One example computing device in the form of a computer 400 may include a processing unit 402, memory 403, removable storage 410, and non-removable storage 412. Although the example computing device is illustrated and described as computer 400, the computing device may be in different forms in different embodiments. For example, the computing device may instead be a smartphone, a tablet, smartwatch, smart storage device (SSD), or other computing device including the same or similar elements as illustrated and described with regard to FIG. 4. Devices, such as smartphones, tablets, and smartwatches, are generally collectively referred to as mobile devices or user equipment.

Although the various data storage elements are illustrated as part of the computer 400, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 400 may include or have access to a computing environment that includes input interface 406, output interface 404, and a communication interface 416. Output interface 404 may include a display device, such as a touchscreen, that also may serve as an input device. The input interface 406 may include one or more of a touchscreen, touchpad, mouse, keyboard, camera, one or more device-specific buttons, one or more sensors integrated within or coupled via wired or wireless data connections to the computer 400, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 400 are connected with a system bus 420.

Computer-readable instructions stored on a computer-readable medium are executable by the processing unit 402 of the computer 400, such as a program 418. The program 418 in some embodiments comprises software to implement one or more methods described herein. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 418 along with the workspace manager 422 may be used to cause processing unit 402 to perform one or more methods or algorithms described herein.

### EXAMPLES

1. A computer implemented method includes receiving a broadcast identifier at a reservation system that was broadcast from a user mobile device via a wireless transmission, generating a notification that a user associated with the user mobile device has arrived, and providing the notification to a user interface to indicate that the user has arrived. The broadcast identifier may be a MAC address received via WiFi received by a router and forwarded to the reservation system.

2. The method of example 1 wherein the broadcast identifier comprises a MAC address received by a router and forwarded to the reservation system.

3. The method of any of examples 1-2 and further including detecting a signal strength of the wireless transmission, comparing the detected signal strength to a threshold signal strength, and inhibiting providing the generation of the notification in response to the comparing.

4. The method of any of examples 1-3 wherein the wireless transmission is received via WiFi.

5. The method of any of examples 1-4 wherein the reservation system comprises a restaurant reservation system.

6. The method of any of examples 1-6 wherein the notification is provided to a display device.

7. The method of example 5 wherein the notification includes a name of the user that is displayed on a screen located in a restaurant.

8. The method of any of examples 1-7 wherein multiple identifiers are received from multiple users corresponding to a multi-person reservation, and wherein the notification is generated and provided in response to more than one user having arrived.

9. The method of example 7 wherein the notification is generated and provided in response to all users having arrived as determined by comparing the received identifiers to identifiers associated with the multi-person reservation.

10. The method of example 9 and further including detecting a signal strength of multiple wireless transmissions, comparing the detected signal strengths to a threshold signal strength, and inhibiting providing the generation of the notification in response to the comparing until all detected signal strengths meet or exceed the threshold signal strength.

11. A machine-readable storage device has instructions for execution by a processor of a machine to cause the processor to perform operations to perform a method. The operations include receiving a broadcast identifier at a reservation system that was broadcast from a user mobile device via a wireless transmission, generating a notification that a user associated with the user mobile device has arrived, and providing the notification to a user interface to indicate that the user has arrived.

12. The device of example 11 wherein the broadcast identifier comprises a MAC address received via WiFi received by a router and forwarded to the reservation system.

13. The device of any of examples 11-12 and further including detecting a signal strength of the wireless transmission, comparing the detected signal strength to a threshold signal strength, and inhibiting providing the generation of the notification in response to the comparing.

14. The device of any of examples 11-13 wherein the wireless transmission is received via WiFi.

15. The device of any of examples 11-14 wherein the reservation system comprises a restaurant reservation system, wherein the notification is provided to a display device, and wherein the notification includes a name of the user that is displayed on a display screen.

16. The device of any of any of examples 11-15 wherein the notification is provided to a display device, wherein the notification includes a name of the user that is displayed on the display device located in a restaurant.

17. The device of any of examples 11-15 wherein multiple identifiers are received from multiple users corresponding to a multi-person reservation, and wherein the notification is generated and provided in response to more than one user having arrived.

18. A device includes a processor and a memory device coupled to the processor and having a program stored thereon for execution by the processor to perform operations. The operations include receiving a broadcast identifier at a reservation system that was broadcast from a user mobile device via a wireless transmission, generating a notification that a user associated with the user mobile device has arrived, and providing the notification to a user interface to indicate that the user has arrived.

19. The device of example 18 wherein the broadcast identifier comprises a MAC address received via WiFi received by a router and forwarded to the reservation system, and wherein the operations further include detecting a signal strength of the wireless transmission, comparing the detected signal strength to a threshold signal strength, and inhibiting providing the generation of the notification in response to the comparing.

20. The device of any of examples 18-19 wherein the notification is provided to a display device, wherein the notification includes a name of the user that is displayed on the display device located in a restaurant and wherein multiple identifiers are received from multiple users corresponding to a multi-person reservation, and wherein the notification is generated and provided in response to more than one user having arrived.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving a broadcast identifier at a reservation system that was broadcast from a user mobile device via a wireless transmission:
generating a notification that a user associated with the user mobile device has arrived; and
providing the notification to a user interface to indicate that the user has arrived.

2. The method of claim 1 wherein the broadcast identifier comprises a MAC address received by a router and forwarded to the reservation system.

3. The method of claim 1 and further comprising:
detecting a signal strength of the wireless transmission;
comparing the detected signal strength to a threshold signal strength; and
inhibiting providing the generation of the notification in response to the comparing.

4. The method of claim 1 wherein the wireless transmission is received via WiFi.

5. The method of claim 1 wherein the reservation system comprises a restaurant reservation system.

6. The method of claim 1 wherein the notification is provided to a display device.

7. The method of claim 5 wherein the notification includes a name of the user that is displayed on a screen located in a restaurant.

8. The method of claim 1 wherein multiple identifiers are received from multiple users corresponding to a multi-person reservation, and wherein the notification is generated and provided in response to more than one user having arrived.

9. The method of claim 7 wherein the notification is generated and provided in response to all users having arrived as determined by comparing the received identifiers to identifiers associated with the multi-person reservation.

10. The method of claim 9 and further comprising:
detecting a signal strength of multiple wireless transmissions;
comparing the detected signal strengths to a threshold signal strength; and
inhibiting providing the generation of the notification in response to the comparing until all detected signal strengths meet or exceed the threshold signal strength.

11. A machine-readable storage device having instructions for execution by a processor of a machine to cause the processor to perform operations to perform a method, the operations comprising:
receiving a broadcast identifier at a reservation system that was broadcast from a user mobile device via a wireless transmission;
generating a notification that a user associated with the user mobile device has arrived; and
providing the notification to a user interface to indicate that the user has arrived.

12. The device of claim 11 wherein the broadcast identifier comprises a MAC address received via WiFi received by a router and forwarded to the reservation system.

13. The device of claim 11 and further comprising:
detecting a signal strength of the wireless transmission;
comparing the detected signal strength to a threshold signal strength; and
inhibiting providing the generation of the notification in response to the comparing.

14. The device of claim 11 wherein the wireless transmission is received via WiFi.

15. The device of claim 11 wherein the reservation system comprises a restaurant reservation system, wherein the notification is provided to a display device, and wherein the notification includes a name of the user that is displayed on a display screen.

16. The device of claim 11 wherein the notification is provided to a display device, wherein the notification includes a name of the user that is displayed on the display device located in a restaurant.

17. The device of claim 11 wherein multiple identifiers are received from multiple users corresponding to a multi-person reservation, and wherein the notification is generated and provided in response to more than one user having arrived.

18. A device comprising:
a processor; and
a memory device coupled to the processor and having a program stored thereon for execution by the processor to perform operations comprising:
receiving a broadcast identifier at a reservation system that was broadcast from a user mobile device via a wireless transmission;
generating a notification that a user associated with the user mobile device has arrived; and
providing the notification to a user interface to indicate that the user has arrived.

19. The device of claim 18 wherein the broadcast identifier comprises a MAC address received via WiFi received by a router and forwarded to the reservation system, and wherein the operations further comprise:
detecting a signal strength of the wireless transmission;
comparing the detected signal strength to a threshold signal strength; and
inhibiting providing the generation of the notification in response to the comparing.

20. The device of claim 18 wherein the notification is provided to a display device, wherein the notification includes a name of the user that is displayed on the display device located in a restaurant and wherein multiple identifiers are received from multiple users corresponding to a multi-person reservation, and wherein the notification is generated and provided in response to more than one user having arrived.
